(19) United States
(12) Patent Application Publication
(10) Pub. No.: US 2008/0301585 A1
(43) Pub. Date: Dec. 4, 2008

(54) METHOD FOR HOTSPOTTING THE VISIBLE WORLD USING VISUAL ICONOGRAPHY OR AUDIO INDICATION

(76) Inventors: Austin P. Murray, Venice, CA (US); Scott D. Lahman, Venice, CA (US); Zachary A. Norman, Venice, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/756,877

(22) Filed: Jun. 1, 2007

(51) Int. Cl. G06F 3/048

(52) U.S. Cl. 715/839

(57) ABSTRACT

The present invention is directed to a method for hotspotting the visible world using visual iconography or audio indication, comprising the steps of: (a) creating a world page and assigning an alphanumeric keyword to the world page; (b) placing a logo and the keyword on a selected surface; (c) viewing the logo and keyword on the selected surface; (d) using a mobile device to send a text message or voice command containing the keyword to a predetermined address, which links the mobile device to a server of an information service provider; (e) receiving the message or voice command and verifying the keyword; and (f) sending data to a hotspot viewer containing relevant information; wherein steps (a) and (b) are performed by a hotspot marker, steps (c) and (d) are performed by the hotspot viewer, and steps (e) and (f) are performed by a server of the information service provider.

### FIELD OF THE INVENTION

This invention broadly relates to communication techniques, and more particularly, to a method for hotspotting (i.e., appending Internet hyperlinks to) the visible world using visual iconography or audio indication.

### BACKGROUND OF THE INVENTION

Location-based services (LBS) are offered by some mobile device networks as a means for sending custom advertising and other information to mobile device subscribers based on their current location. In a typical push LBS implementation, the information service provider receives the device location from a GPS chip built into the mobile device and transmits, or pushes, information to the device based on its location. Alternatively, the information service provider may employ cellular tower triangulation to locate mobile devices in physical space. Location-based services may allow the subscriber to receive information or advertising relating to a nearby business of a certain type, such as a supermarket, a coffee shop, a video store, or a French restaurant. For example, a mobile device subscriber approaching a nearby STARBUCKS coffee shop may receive a message including a coupon for a free coffee when purchasing another item.

There are several notable drawbacks to traditional push location-based services, including information privacy issues concerning the ability of merchants to sense subscribers in their vicinity and then send them unsolicited offers. In addition, many consumers find the idea of their mobile device constantly buzzing with unsolicited promotions to be annoying and invasive. A sophisticated software system would be required to mediate between which offers should be accepted to a particular device, when the offers should be accepted, and how often. Moreover, the large majority of mobile phones in the market today are not equipped with location-aware technologies. Additionally, as with unwanted SMS traffic in current cell phone data traffic and with “pop-up” advertising on the Internet, the carriers would be obliged to allow users to opt-out of the reception of such pushed and unsolicited mobile ads, which would render the carriers largely invisible to the mass market.

Other conventional LBS systems feature methods that rely on visible barcodes designed to be read by mobile phones equipped with cameras and the appropriate software to decode the barcodes. Such methods require a user to activate the camera in their mobile phone, take a picture of the barcode, and submit it to a server. The server then identifies the barcode and provides the user with relevant information about the object to which the barcode refers. One drawback of using these methods is that barcodes are not user friendly because they have traditionally been designed for businesses to track inventory. Consequently, since there is no inherent call to action, consumers often do not know what the barcodes are for, even when prominently placed on a product or in a given location. A further drawback is that phone manufacturers (OEMs), wireless carriers, businesses, and other important companies in the mobile phone service value chain must likely first agree on a standard set of barcodes and implementation procedures before barcodes can be deployed to the mass market. Additionally, camera technologies must be significantly improved before they are capable of reading the barcodes at the appropriate resolution. Furthermore, barcodes do not work well on outdoor advertising where the consumer is at a great distance from the target barcode.

Further LBS systems are based upon image recognition. Some known methods again rely on a camera-equipped phones to take a picture of an object or advertisement, and send it to a server to be analyzed by image recognition technology. The server then sends the user relevant information about the target object or advertisement. One drawback to these methods is that image recognition technology is not capable of cataloguing all of the potential objects and images in the world. Additionally, issues around image resolution and lighting affect the quality of the image and make it even more difficult to correctly identify and provide appropriate information about the image. A further drawback is that consumers eager to try this technology will likely get many “no information” responses since there are a vast number of objects in the world and identifying these objects correctly using technology is extremely difficult. Once consumers receive wrong information or no information a few times, they will be less likely to use the service again.

### SUMMARY OF THE INVENTION

The present invention is directed to a method for hotspotting (i.e., appending Internet hyperlinks to) the visible world using visible iconography or audio indication. In particular, the invention is used to convey the presence of digital information in the physical world using real world Internet hyperlinks. Similar to how hyperlinks on the World Wide Web link individual Web pages to other Web pages, the invention sets forth a method for providing hyperlinks in the physical world that combine digital information with physical space. Just as HTML and other Web markup languages allow millions of users worldwide to create Websites, the invention further provides a simple mechanism for creating these physical hyperlinks and populating the same with dynamic content. Through the placement of a visible icon or audio indication in one or more predetermined locations, the system and method of the invention convey that there is a hotspot providing more information (i.e., metadata) about a person, place, thing, or idea. A subscriber may acquire more information about the person, place, thing, or idea by interacting using a mobile device with the visible icon or audio indication that visually represents the hotspot. The invention also provides a method for creating a hotspot in physical space, linking it to new information services (e.g., world pages) and/or existing information services (e.g., the Internet and World Wide Web), and mapping the hotspot to physical space through street address or GPS geolocation coordinates.

A preferred method for hotspotting the visible world using visual iconography or audio indication, in accordance with the principles of the invention, comprises the steps of: (a) selecting a suitable surface for a world mark; (b) creating a world page (i.e., a personalized web page) and assigning an alphanumeric keyword to the world page; (c) placing a logo and the keyword on the selected surface; (d) viewing the logo and keyword on the selected surface; (e) using a mobile device to send a text message (or voice command) containing the keyword to a predetermined address, which links the mobile device to a server of an information service provider; (f) receiving the message containing the keyword from a hotspot viewer; (g) verifying the keyword; and (h) sending data to the viewer containing relevant information; wherein steps (a)-(c) are performed by a hotspot marker, steps (d) and (e) are performed by the hotspot viewer, and steps (f)-(h) are performed by a server of the information service provider.

In the above method, the relevant information pertains to a product, person, place, thing, or idea associated with the keyword, and may include simple text information. In addition, the relevant information may include links to other relevant Internet sites. The step of sending data to the hotspot viewer containing relevant information may comprise sending an SMS message including hotlinks which prompt the user to connect to a WAP site and/or automatically launch a video player with relevant content. After the server sends the data, the hotspot viewer receives the data and opens the message, wherein the user interacts with the data using any mode of communication native to the mobile device. For example, the mode of communication may comprise SMS, WAP, XML, HTML, CHTML, video, pictures, audio, or any other multimedia or Internet content. Additionally, the experience is agnostic with regard to transport technology.

In the above cases, SMS is the main and/or initial method of data transport and usage initiation. However, initially accessing the information can be accomplished with any type of data transfer including, but not limited to, email, SMS, WAP, XML, HTML, CHTML, TCP/IP, SMTP SMPP, FTP, HTTPS, COM OBJECT. In addition, various proprietary methods may be employed to send a custom data stream to the server from within a client application, either by entering the keyword into the client manually (as one would an SMS as described above) or by simply pushing a button on the device that accesses the device's GPS data and then automatically pulls the appropriate information based solely on location and/or other relevant data available to the device (e.g., directional orientation).

The method may be based upon hotspotting technology that is device agnostic. The step of placing a logo and the keyword on the selected surface may further comprise placing the predetermined address on the selected surface, wherein the predetermined address comprises a mnemonic for an SMS short code or a URL. The surface may be virtual or real, permanent or transient, portable or stationary, animated, projected, or broadcast, and the iconography may be printed or even scrawled with a pen or marker. Additionally, the surface may be animated, projected, or broadcast. According to the invention, the world page includes reserved space for advertisements. The world mark may comprise a fixed type general world mark, a mobile type general world mark, a personal world mark, or a custom world mark.

An additional method for hotspotting the visible world using visual iconography or audio indication, comprises the steps of: (a) creating a world page and assigning an alphanumeric keyword to the world page; (b) placing a logo and the keyword on a selected surface; (c) viewing the logo and keyword on the selected surface; (d) using a mobile device to send a text message (or voice command) containing the keyword to a predetermined address, which links the mobile device to a server of an information service provider; (e) receiving the message and verifying the keyword; and (f) sending data to a hotspot viewer containing relevant information; wherein steps (a) and (b) are performed by a hotspot marker, steps (c) and (d) are performed by the hotspot viewer, and steps (e) and (f) are performed by a server of the information service provider.

In the above method, the relevant information pertains to a product, person, place, thing, or idea associated with the keyword. In operation, the hotspot viewer receives the data and opens the message, and wherein the user interacts with the data using any mode of communication native to the mobile device. Additionally, the step of placing a logo and the keyword on the selected surface may further comprise placing the predetermined address on the selected surface. The predetermined address may comprise a mnemonic for an SMS short code or a URL. According to the invention, the method may be based upon hotspotting technology that is device agnostic.

### BRIEF DESCRIPTION OF THE DRAWINGS

FIGS. 1A-1C are schematic diagrams illustrating world marks in accordance with the principles of the invention;

FIGS. 2A-2C are schematic diagrams illustrating the creation of a world mark in accordance with the principles of the invention;

FIGS. 3A-3C are schematic diagrams illustrating user interaction with a world mark in accordance with the principles of the invention; and

FIG. 4 is a schematic diagram illustrating a preferred method for hotspotting using visual iconography or audio indication in accordance with the principles of the invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention is directed to a method for hotspotting the visible world using visual iconography or audio indication. According to a method of the invention, system users may easily create micro-sites (such as world pages) that are easy to view on a myriad of mobile devices via the simple sending of a common short code or alphanumeric keyword. Each micro-site preferably has a unique short code or keyword that, when contained in a SMS (Short Message Service) message, returns to the sender mobile access to the particular micro-site. According to the notion of “world marking”, each micro-site is tied to the real world context in which it is displayed. The invention provides a simple and automated tool for users to create these micro-sites. Users will advertise the micro-site's short code or keyword (e.g., as a visual stimulus or audio indication) by whatever means they choose and to whatever extent desired.

In a preferred implementation, the micro-sites are completely agnostic from a device perspective and can be viewed in any major markup language including without limitation, CHTML, HTML, or WAP, and can also be viewed as a series of SMS messages. Additionally the information service provider may provide a special service to larger paying clients to make custom world sites with more embedded rich content and robust custom functionality. Although SMS is employed in an exemplary implementation of the invention as the primary and/or initial method of data transport and usage initiation, other types of data transfer may be employed such as email, SMS, WAP, XML, HTML, CHTML, TCP/IP, SMTP SMPP, FTP, HTTPS, COM OBJECT, without departing from the scope of the invention. In addition, various proprietary methods may be employed to send a custom data stream to the server from within a client application, either by entering the keyword into the client manually (as one would an SMS as described above) or by simply pushing a button on the device that accesses the device's GPS data and then automatically pulls the appropriate information based solely on location and/or other relevant data available to the device (e.g., directional orientation).

In general, there are three different types of world sites or “world marks”, including “general world marks”, “personal world marks” and “custom world marks”. The fundamental differences between these marks lies in the intent of the user who made them. In particular, general world marks are like bookmarks in the real world used to mark special places and things, wherein the “marker” desires more information capable of being delivered to the user. There are two sub types of general world marks including fixed and mobile.

As an example of a fixed type general world mark, a user walks into a taco shop to get some tacos and she sees the alphanumeric keyword for the taco shop's world site on the menu. Wanting to know more and to “world mark” (i.e., bookmark) this restaurant, she sends the appropriate keyword in the body of an SMS message to the information service provider and waits for a response. After a few moments, a text comes back to her mobile device containing a link that she clicks, thereby launching a WAP browser (in this example, the user's device is capable of WAP). Accordingly, she may now interact with the taco shop's world page. By way of example, the title may read, “Timmy's Tacos and Fruit Salad Too!” with the Timmy's Tacos logo presented below the title. Further down the page is a mission statement and links to four other pages including (i) a complete menu, (ii) a “great taco's of history” info page, (iii) hours of operation, and (iv) a reservation link. Near the bottom of the main page is an “email me this” button with a clear note that this is ALL you will be mailed. Below this button is a “sign the guest book” button, whereby the taco proprietor will give away a fruit salad to every customer who opts-in to the mailing list (i.e., signs the guest-book). All of the headings and page titles are chosen by the taco proprietor.

As an example of a mobile type general world mark, a user has a mobile coffee making business called, “That's Coffee To you!”, and drives a van to places where people are known to congregate. In order to advertise the mobile coffee business, he world marks the van to give passersby “virtual fliers” and to deepen his relationship with his existing customers. From a tool perspective, the creation of a mobile type general world mark differs from a fixed type general world mark only in that a mobile mark does not include an associated location.

Personal world marks are mobile sites used in a personal way to let a marker essentially mark herself in a way similar to a social network. In a particular case, the user intends to mark herself so that if she so chooses she can display her alphanumeric keyword on her person (e.g., in some cool or unique way), such that others can then get access to her “personal page” in real time including the information she wants people to see. By way of example, she may be single and looking for guys who like the rock band Radiohead. In this manner, personal world marks can turn any bar into a singles bar. Imagine the advantage of knowing whether the good-looking patron at the bar is single before asking to buy her a drink. The creation tool for personal pages is slightly different than for general world marks in that the headings and page titles are chosen for the user rather than by the user. In one implementation of the invention, the headings include, “About me”, “Who I'd like to meet”, “Things I'm Into”, “Status”, “General Location (of Home)”, and other headings. In this way, users can search various personal pages to find markers they are interested in.

Custom world marks are custom mobile sites created for clients that desire more robust and dynamic content than can be delivered in a “stock” world mark. In an example of a custom world mark, a special experience is created for fans of the band Interpol. While on tour, the band may promote a world site on stage (or otherwise) that provides the fans with a dynamic and truly mobile location-based experience.

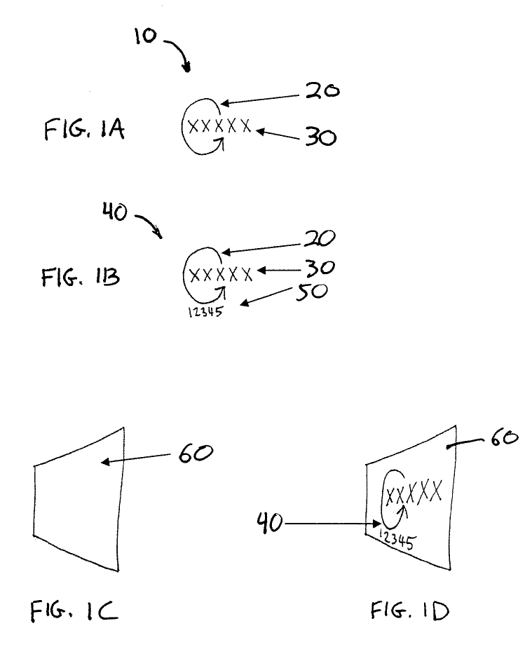

FIG. 1A depicts a basic world mark 10 in accordance with the principles of the invention. In the illustrated embodiment, the world mark 10 contains two components including a logo 20 and a keyword 30. Functionally, the logo 20 represents the notion that a given surface is marked, or tagged, as an electronic link between the viewer and the entity that posted the mark (i.e., the marker). The keyword 30 provides the world mark 10 with its uniqueness and may be selected by the marker.

FIG. 1B depicts a further world mark 40 in accordance with the principles of the invention. The world mark 40 is similar to the word mark 10 of FIG. 1, and like elements have been numbered accordingly. In addition, the world mark 40 further comprises an address 50. The address 50 may be expressed using any electronic addressing method including without limitation Short Codes and URLs. According to additional embodiments of the invention, the logo 20 may be the only viewable component of the world mark 40, wherein a subscriber merely points their mobile device at the logo 20 and clicks to receive information regarding a particular product. The mobile device may include GPS with directional capabilities. Further embodiments of the invention may feature a world mark comprising a keyword, but no logo.

Referring to FIG. 1C, a world mark may be placed on nearly any surface (such as surface 60), virtual or real, permanent or transient, portable or stationary, animated, projected, or broadcast, and the iconography may be printed or even scrawled with a pen or marker. Examples of suitable surfaces for a world mark 40 of the invention include, but are in no way limited to, a restaurant window, the side of a building, a billboard advertisement, a television screen, and a T-shirt. In FIG. 1D, the world mark 40 of FIG. 1B is depicted on surface 60.

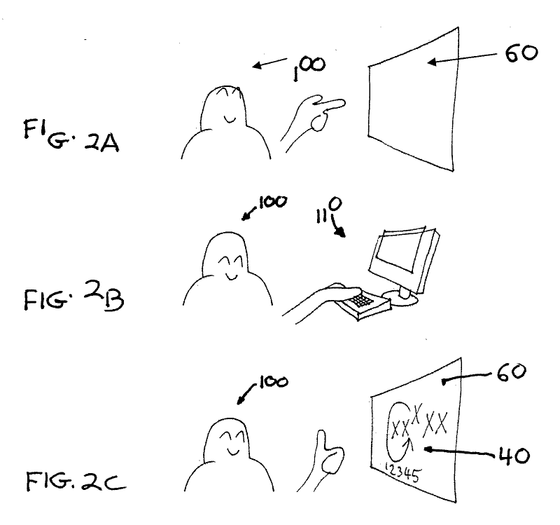

Referring to FIG. 2A, a marker 100 that desires to link people electronically to a surface, initially selects surface 60 for the placement of a world mark. In FIG. 2B, the marker 100 is depicted at a computing station 110 during the creation of a world page using an Internet based tool. As would be appreciated by those of skill in the art, the marker may create a world site using means other than a computer (e.g., a mobile device) without departing from the scope of the invention. The marker 100 preferably assigns a keyword to the world page. Referring to FIG. 2C, the marker 100 completes the world mark 40 by placing the logo 20, the keyword 30 and (optionally) the address 50 on the chosen surface 60.

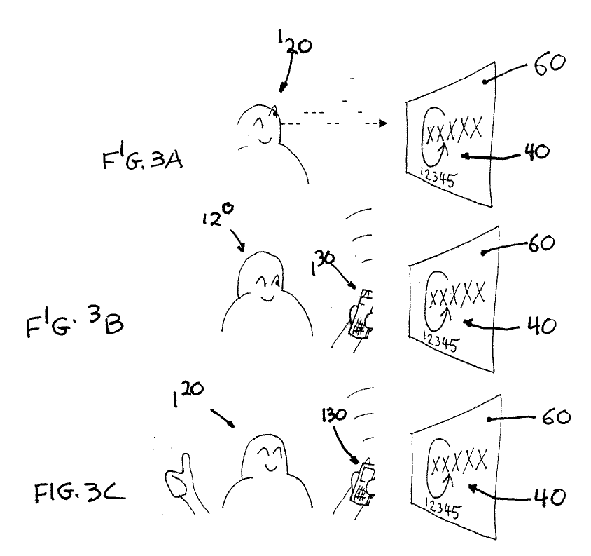

Referring to FIG. 3A, a user 120 sees a world mark 40 on a surface 60 that is of interest to the user 120. As set forth above, the surface may be virtual or real, permanent or transient, portable or stationary, animated, projected, or broadcast, and the iconography may be printed or even scrawled with a pen or marker. In FIG. 3B, the user 120 holding mobile device 130 enters the alphanumeric keyword 30 into the subject line of a text message, and sends it to the address 50 (e.g., an SMS short code). This links the mobile device 130 to a server of the information service provider. In FIG. 3C, the user 120 receives a response from the server in the form of metadata, and the user may now interact freely with the world site of the marker 100.

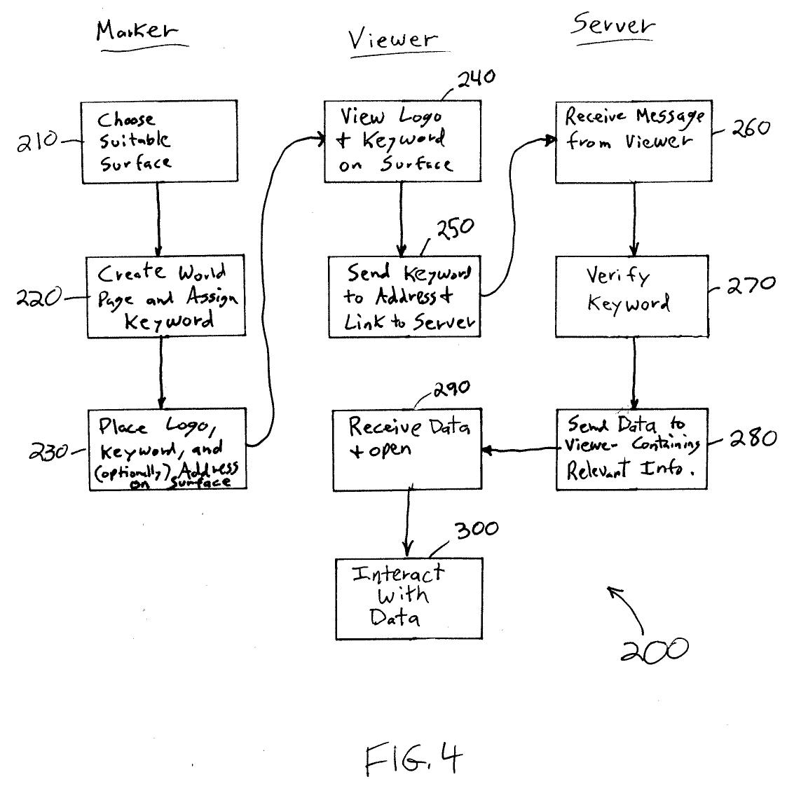

Referring to FIG. 4, a preferred method 200 for hotspotting the real world using visual iconography and wireless technology will now be described. Specifically, step 210 involves a marker choosing a suitable surface (e.g., an advertising billboard) for a world mark. In step 220, the marker creates a world page and assigns an alphanumeric keyword to the world page. In step 230, the marker places a logo and the keyword on the selected surface. In some embodiments of the invention, the marker may also place the address on the chosen surface. In step 240, a viewer having a mobile device views the logo and keyword on the selected surface. Step 250 involves the viewer using the mobile device to send a text message (or voice command) containing the appropriate keyword to the address, which links the mobile device to a server of the information service provider.

With further reference to FIG. 4, step 260 involves the server receiving the message containing the keyword from the viewer. In step 270, the server verifies the keyword, and in step 280, the server sends data to the viewer containing relevant information. This information may pertain to a product associated with the keyword, or information about a person, place or thing associated with the keyword. The information may include simple text information about the product, as well as links to other relevant Internet sites (e.g., to a person's MySpace profile). In addition, hotlinks in the initial-response SMS message may (i) prompt the user to connect to the richer WAP world with pictures, graphics, and e-commerce, and/or (ii) automatically launch a video player with relevant content. In step 290, the viewer receives the data and opens the message. Step 300 involves the viewer interacting with the data using any mode native to their mobile device including, but not limited to, SMS, WAP, XML, HTML, CHTML, video, pictures, audio, and any other multimedia or Internet content of any kind.

According to the invention, a marker that desires to link people electronically to a chosen surface initially creates a world mark using the hotspotting technology of the invention. By way of example, consider a Mexican restaurant owner that desires to strengthen relationships with her customers. The restaurant owner logs onto a world mark creation website of the information service provider and begins a simple world mark set-up wizard. Following the set-up wizard, she names and fills in various test fields, uploads her logo. Additionally, she may set up a simple coupon-for-guestbook scheme. Then, the restaurant owner prints out an image of the world mark and tapes it to her menu board. She may now promote her world mark verbally or otherwise, and wait for customer interaction with the world mark.

Continuing the above example, a user spots the world mark on the menu board of a Mexican restaurant. The user, liking the food and wanting to easily link to this restaurant, sends the world mark's keyword to the short code (i.e., address) using a mobile device. After a few moments, the user receives an SMS from a server (of the information service provider) that constitutes the “front page” of the Mexican restaurant's world page. The user then opens the SMS, which contains a link to a WAP page (since her mobile device is configured to handle WAP). The WAP page contains the restaurant's simple world page.

According to the principles of the invention, the method for hotspotting may involve the use of an audio indication in lieu of or in addition to visual iconography. By way of example, a person is listening to a radio station when he hears an audio indication along with a spoken keyword and address (and any accompanying instructions). Responsive to the audio cue, the person activates his mobile device, enters or speaks the keyword into his mobile device and sends the information to the indicated address. The person then receives the hotspot information, in the form of metadata, about a person, place, thing, or idea. The only difference here from the previous examples in the description is that the call-to-action is aural as opposed to visual.

The world pages of the invention are configured to be “mobile in design” in that the pages are small and designed to be consumed by mobile device users on the go. According to a preferred implementation, each world page includes reserved space for advertisements, and each message is relatively short and is delivered quickly. In addition, the hotspotting technology is based upon the principles of device agnosticism, whereby a user does not need to know whether or not his mobile device can handle certain types of information. For example, in the event that the user's device can't handle WAP, the same content will be delivered to the mobile device using SMS with an SMS type menu and action structure.

The hotspotting technology of the present invention features visual iconography for location-based services. This visual call-to-action approach is a fundamental shift away from the current methods of providing location-based services, which tend to focus on location-aware technologies to sense the location of a device and then push the relevant information to the user. By contrast, the present invention enables all information to be pulled to consumers on demand, as opposed to pushed at them by businesses.

In accordance with the principles of the invention, the visual iconography includes various inputs that are submitted by the user, including: (i) a graphical icon, (ii) an alphanumeric keyword (which makes the icon unique to the owner of the keyword), and (iii) an address (e.g., an SMS short code). In a preferred implementation, the address comprises a number that is also a word. For example, the address may comprise “GOGOS”, which is a mnemonic for an SMS short code (“60606”) that may serves as an SMS domain name for location-based information of the information service provider. The invention also may utilize certain alternative technologies (e.g., GPS, gyro, voice recognition, near-field communications, image recognition, and optical character recognition (OCR)) to automate the process, and these technologies may obviate the need for submitting one or more of the above inputs.

The above-identified combination of inputs (i.e., iconography, keyword, address) is a preferred arrangement of inputs that may be used with SMS, which is available on nearly all mobile phones. In operation, the user sees the icon, enters the alphanumeric keyword into the subject line of a text message, and sends it to the SMS short code. The relevant metadata is then sent to the user. An alternative combination of inputs, (iconography, keyword), may be employed in certain circumstances, e.g., if sending an SMS is not necessary or this feature is automated on the mobile device. For example, a hard-coded button on the device may automatically populate the SMS address, leaving only the keyword to be inputted by the user. Other technologies that may obviate the need for address input include voice recognition, image recognition or OCR. Specifically, a user may speak the keyword into his device, which is then translated server-side using voice recognition, or activate the camera on his device to record the image of the keyword, which is then translated server-side using image recognition or OCR.

According to further embodiments of the invention, the need for a keyword and/or an address may be obviated using different alternative technologies, such as GPS and gyro, or near-field communications (e.g., Wi-Fi, Bluetooth, RFID). Using location-aware technologies such as GPS and Bluetooth, the GPS network will know where the user is and which hotspots are nearby, making it faster and more convenient for the user to get the information desired. In the case where the user has a mobile device with GPS and gyro capabilities and a hard-coded button dedicated to the information service. In operation, the user sees an icon, points the mobile device at the icon, and presses the hard-coded button dedicated to the information service. GPS identifies the geolocation of the user, while gyro identifies which direction the device is pointed. In addition, the server (which has a log of all icons in the system) identifies which icon the user is interested in. Without delay, the user receives metadata about the subject of the icon.

In the case where there exist multiple icons in a very small area unable to be distinguished sufficiently through location-aware technologies, the system will prompt the user to choose from a list of existing icons registered at or near the location of the user, with the most likely icon listed first. In embodiments wherein near-field communications technology are implemented, the icon includes an embedded local chip, which signals the device exactly which unique icon is present, and then sends the relevant metadata about the icon's subject to the device.

The technique of using visual iconography enables an overlay of digital information to be mapped onto the real world. The visual iconography may be placed on nearly any existing physical surface (e.g., buildings, vehicles, streets, outdoor advertising, newspapers, magazines), virtual surface (e.g., TV advertising, Internet websites, video games), and people (real or virtual). The icons may be anchored to physical space via geolocation coordinates (either through a physical street address or GPS), thus providing a true virtual overlay to physical space. According to the invention, a mechanism is provided to enable users to create physical hotspots. This mechanism provides users with the ability to mark a physical or virtual location with a hotspot that others will be able to interact with. The visual iconography is simple enough that it may be drawn by hand on a surface or printed from the system of the invention. Users may also add geolocation coordinates of a selected hotspot so that it may be tracked on the website and made available to others via location-aware technologies like GPS.

Traditionally, a user that wants to market an SMS short code must fill out a detailed application to the short code registry, and it costs a minimum of $12,000 per year plus $0.05 per message to operate. Furthermore, short codes are numbers that have so far proven unattractive to advertisers since numbers are so generic. By contrast, the present invention utilizes a keyword that may comprise a mnemonic for a short code number, which enables users to market and communicate through a short code without incurring the headache or cost of operating the short code. Additionally, keywords are words rather than numbers, and are therefore much more attractive to advertisers.

The present invention enables the playback of audio, video, or multimedia on demand to a location. According to some embodiments, a visible button is included on the mobile devices such that when a user pushes the button, the system searches for nearby hotspots. For example, a user standing in front of an outdoor advertisement for the new BMW 5 Series automobile may use his mobile device to acquire additional information. With the click of a button, he may view the latest TV commercial for the car on his mobile phone.

Gyro technology is directional technology that, operating in a manner similar to that of three dimensional compass indicating not only cardinal directions but also azimuth, enables a device to know in which direction it is being pointed and/or how it is being tilted in relation to the ground. If a mobile device is equipped with gyro, its user is able to point the devices at objects which are identified exactly in conjunction with GPS technology. Image recognition technology identifies the substantive meaning of an image using a database of images and matching the image in question to the existing database of all images. Accessing the camera on a device, a user may record an image of a selected icon and keyword, and send the image to the information service provider's server. In response, the server matches the image of the keyword against a known database of keywords, and then sends the appropriate metadata about the icon's subject.

OCR technology identifies printed letters using a camera. Accessing the camera on a device, a user may record the image of the icon and keyword, and send the image to the server. The server then identifies the keyword and sends the appropriate metadata about the icon's subject to the user's device. Voice recognition technology may be implemented to make hotspotting technology of the invention easier to use. For example, when a user sees an icon with keyword, he presses a button on his mobile device and states the name of the keyword into the device. Server side, the voice is translated to a word using voice recognition technology, and then the appropriate metadata is sent to the user.

The principles of the invention may be employed in conjunction with near-field communications such as Wi-Fi, Bluetooth, and/or RFID, in order to further automate the invention and provide a better user experience. By way of example, an icon of the invention may include a communications chip or signal embedded therein, which mobile devices can sense when in range of the icon. When the user sees an icon, she presses a button on the mobile device, at which time the device senses the local near-field communications signal coming from the icon. In response, the server sends the appropriate metadata to the mobile device.

As used herein, the term “network” refers to any configuration of data processing devices and software connected for information interchange. For example, the network may comprise the Internet, an intranet, a local area network (LAN), a wide area network (WAN), a virtual private network (VPN), an internetwork, a personal area network (PAN), a campus area network (CAN), a metropolitan area network (MAN), or any other configuration of data processing devices and software connected for information interchange.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

1. A method for hotspotting the visible world using visual iconography or audio indication, comprising the steps of:
(a) selecting a suitable surface for a world mark;
(b) creating a world page and assigning an alphanumeric keyword to the world page;
(c) placing a logo and the keyword on the selected surface;
(d) viewing the logo and keyword on the selected surface;
(e) using a mobile device to send a text message or voice command containing the keyword to a predetermined address, which links the mobile device to a server of an information service provider;
(f) receiving the message containing the keyword from a hotspot viewer;
(g) verifying the keyword; and
(h) sending data to the viewer containing relevant information;
wherein steps (a)-(c) are performed by a hotspot marker, steps (d) and (e) are performed by the hotspot viewer, and steps (f)-(h) are performed by a server of the information service provider.

2. The method of claim 1, wherein the relevant information pertains to a product, person, place or thing associated with the keyword.

3. The method of claim 1, wherein the relevant information includes simple text information.

4. The method of claim 1, wherein the relevant information includes links to other relevant Internet sites.

5. The method of claim 1, wherein the step of sending data to the hotspot viewer containing relevant information comprises sending an SMS message including hotlinks which prompt the user to connect to the WAP and/or automatically launch a video player with relevant content.

6. The method of claim 1, wherein the hotspot viewer receives the data and opens the message.

7. The method of claim 6, wherein the user interacts with the data using any mode of communication native to the mobile device.

8. The method of claim 7, wherein the mode of communication is selected from the group consisting of, SMS, WAP, XML, HTML, CHTML, video, pictures, audio, and any other multimedia or Internet content.

9. The method of claim 1, wherein the step of placing a logo and the keyword on the selected surface further comprises placing the predetermined address on the selected surface.

10. The method of claim 9, wherein the predetermined address comprises a mnemonic for an SMS short code or a URL.

11. The method of claim 1, wherein the surface is virtual or real, permanent or transient, printed or scrawled, portable or stationary.

12. The method of claim 1, wherein the surface is animated, projected, or broadcast.

13. The method of claim 1, wherein the world page includes reserved space for advertisements.

14. The method of claim 1, wherein the method is based upon hotspotting technology that is device agnostic.

15. The method of claim 1, wherein the predetermined address comprises a number that is also a word.

16. The method of claim 1, wherein the world mark comprises a fixed type general world mark, a mobile type general world mark, a personal world mark, or a custom world marks.

17. A method for hotspotting the visible world using visual iconography or audio indication, comprising the steps of:
(a) creating a world page and assigning an alphanumeric keyword to the world page;
(b) placing a logo and the keyword on a selected surface;
(c) viewing the logo and keyword on the selected surface;
(d) using a mobile device to send a text message or voice command containing the keyword to a predetermined address, which links the mobile device to a server of an information service provider;
(e) receiving the message and verifying the keyword; and
(f) sending data to a hotspot viewer containing relevant information;
wherein steps (a) and (b) are performed by a hotspot marker, steps (c) and (d) are performed by the hotspot viewer, and steps (e) and (f) are performed by a server of the information service provider.

18. The method of claim 17, wherein the relevant information pertains to a product, person, place or thing associated with the keyword.

19. The method of claim 17, wherein the hotspot viewer receives the data and opens the message, and wherein the user interacts with the data using any mode of communication native to the mobile device.

20. The method of claim 17, wherein the step of placing a logo and the keyword on the selected surface further comprises placing the predetermined address on the selected surface, and wherein the predetermined address comprises a mnemonic for an SMS short code or a URL.

21. The method of claim 17, wherein the method is based upon hotspotting technology that is device agnostic.

22. A method for hotspotting the visible world using visual iconography or audio indication, comprising the steps of:
(a) selecting a suitable surface for a world mark;
(b) creating a world page and assigning an alphanumeric keyword to the world page;
(c) placing the keyword on the selected surface;
(d) viewing the keyword on the selected surface;
(e) using a mobile device to send a text message or voice command containing the keyword to a predetermined address, which links the mobile device to a server of an information service provider;
(f) receiving the message containing the keyword from a hotspot viewer;
(g) verifying the keyword; and
(h) sending data to the viewer containing relevant information;
wherein steps (a)-(c) are performed by a hotspot marker, steps (d) and (e) are performed by the hotspot viewer, and steps (f)-(h) are performed by a server of the information service provider.
